(19) United States
(12) Patent Application Publication
(10) Pub. No.: US 2002/0188729 A1
(43) Pub. Date: Dec. 12, 2002

(54) Collaboration control system and method

(76) Inventors: Rui Zhou, Clifton Park, NY (US); Yu Wang, Clifton Park, NY (US); Hong Dai, Schenectady, NY (US); George Ghanime, Ballston Spa, NY (US)

Correspondence Address: NIXON & VANDERHYE P.C., 1100 North Glebe Road, 8th Floor, Arlington, VA, 22201, US

(21) Appl. No.: 09/878,327

(22) Filed: Jun. 12, 2001

(51) Int. Cl. G06F 15/16

(52) U.S. Cl. 709/227

(57) ABSTRACT

A collaboration control system and method for managing use of a plurality of resources includes a user information collection routine for collecting user account information for a user using the resources and creating an LDAP user account entry. A mirror routine automatically generates mirror persons from the user account entry and maintains the mirror persons within the resources to identify the user across the resources.

### COPYRIGHTS RESERVED

A portion of the disclosure of this patent document contains material which is subject to copyright protection. The copyright owner has no objection to the facsimile reproduction by anyone of the patent document or the patent disclosure as it appears in the Patent and Trademark Office patent files or records, but otherwise reserves all copyright rights whatsoever.

### TECHNICAL FIELD

The present invention generally relates to a collaboration system and, more particularly, to web-enabled control for a collaboration system.

### BACKGROUND OF THE INVENTION

FIG. 1 shows a collaboration system 10 that permits a plurality of different users 12 (typically from distributed locations) to use various resources 14 in a collaborative manner via collaboration control system 15. Resources 14 may include, for example, databases. The different users 12 may include employees, customers, suppliers, business partners and the like collaborating on a common project or projects. For example, a company's employees may collaborate via collaboration system 10 with a supplier to the company in order to arrive at a final design of a product at a particular cost per unit. Users 12 may connect to collaboration control system 15 using devices (e.g., computer systems, mobile telephones, personal digital assistants, etc.) suitably configured for communication over conventional wired and/or wireless networks.

Various collaboration control systems are commercially available. In some of these systems (such as eMatrix 9™ available from MatrixOne®, Inc.), users are identified through a “person”. A “person” definition enables a user to own and access resources contained within the collaboration system. The definition also defines a user's relationship to others by “groups” who use the collaboration system. The “person” definition also identifies the “role” that a user plays in an organization, i.e., the user's job function. A “person” is defined inside a particular resource (e.g., database). Because large scale applications typically involve multiple resources, duplicate “persons” have to be created for each resource, each typically having its own user name and password. Administratively, it is tedious to maintain, update and purge “persons”. Moreover, serious confusion can be created among users of the resources because of inconsistent use of user names and passwords.

### SUMMARY OF THE INVENTION

The collaboration control system and method described herein overcome the aforementioned problems and provides other advantages. The collaboration control system and method manage use of a plurality of resources such as databases and, for example, streamline account management in a collaboration system in which heterogeneous resources are involved. A user information collection routine collects user account information (e.g., user name, password(s), e-mail address(es), etc.) for using the resources and adds a user account entry to an LDAP server. A mirror routine automatically generates mirror persons from the user account entry and maintains the mirror persons within the resources to identify the user across the resources. In this way, the user may use the same username and the same password to identify himself/herself across multiple resources. This eliminates confusion among users resulting from multiple user names/passwords.

In one illustrative implementation, the LDAP server is part of a collaboration control system in a collaboration system that permits a plurality of different users to use various resources in a collaborative manner. When the user logs in to collaboration system, he/she will authenticate him/herself against the LDAP server to map himself/herself with a mirror person in the resources.

The collaboration control system may be web-enabled, i.e., a user operates through the world wide web (WWW) so that no extra software needs to be installed on the client side. The system may also include a self-registration routine that permits a user to create an account if an account does not exist. A profile management routine may also be provided so that a user can update his/her own profile (e.g., e-mail address, password, affiliations, etc.). Finally, a password notification routine may be provided so that a user can retrieve forgotten passwords via e-mail.

### BRIEF DESCRIPTION OF THE DRAWINGS

The accompanying drawings, which are incorporated in and constitute a part of the specification, illustrate various embodiments of the present invention and, together with the general description given above and the detailed description provided below, serve to explain the principles of the invention.

FIG. 1 shows a collaboration system 10.

FIG. 2 shows an example collaboration system 16 in accordance with an embodiment of the present invention.

FIG. 3 shows an LDAP directory that comprises a collection of hierarchically related objects.

FIG. 4 shows the contents of a schema object contained in the LDAP directory.

FIG. 5 shows an example LDAP user template.

FIG. 6 shows an example sign-up routine.

FIG. 7 shows an example profile management routine.

FIG. 8 shows an example sign-in routine.

FIG. 9 shows example account manager routine.

FIG. 10 shows an example computer system usable for executing the routines shown in FIGS. 6-9.

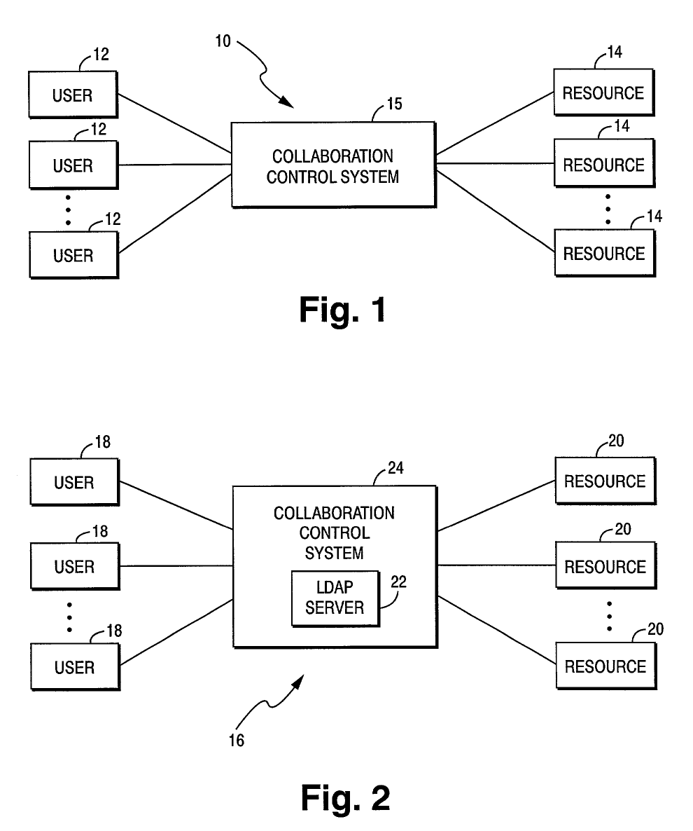

### DETAILED DESCRIPTION

The system and method described herein are implemented using a Java web application and using the integration of Lightweight Directory Access Protocol (LDAP) and a collaboration control system. The collaboration system and method manages use of a plurality of resources and includes a user information collection routine for collecting (e.g., via the world wide web) user account information for using the resources and adding a user account entry to an LDAP server. A mirror routine automatically generates mirror persons from the user account entry and maintains the mirror persons within the resources to identify the user across the resources. Multiple mirror persons are generated, i.e., one for each different resource. In this way, the user may use the same username and the same password to identify himself/herself across multiple resources. This eliminates confusion among users resulting from multiple user names/passwords. The mirror routine is based on the user's specific request to look for particular resources to generate the mirror persons. The specific request refers to the portion of collaboration system with which the user is interacting.

As shown in FIG. 2 collaboration system 16 permits a plurality of users 18 to use various resources 20 in a collaborative manner for planning or decision-making. An LDAP server 22 is part of collaboration control system 24. When a user logs into collaboration system 16, he/she will authenticate himself/herself against the LDAP server 22 to map himself/herself with a mirror person in the resources. Collaboration control system 24 may be one or more computer systems. If more than one computer system is used, the computer systems may be arranged in a network. LDAP server 22 may be a stand-alone server incorporated in such a network or may be part of a server that performs other collaboration system functions.

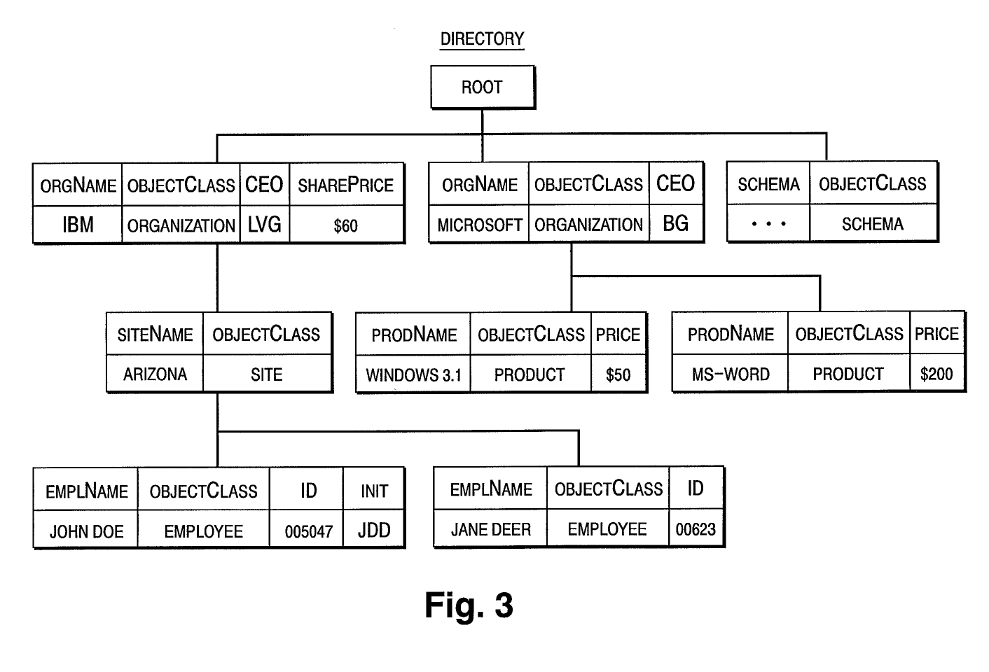

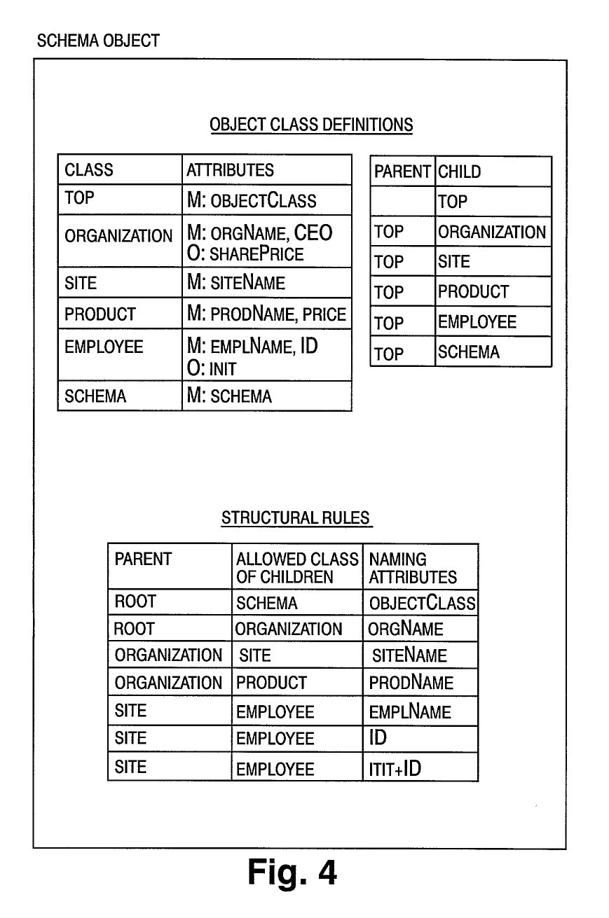

LDAP is a protocol that enables corporate directory entries to be arranged in a hierarchical structure that reflects geographic and organizational boundaries. Using LDAP, companies can map their corporate directories to actual business processes, rather than arbitrary codes. LDAP is based on the X.500 standard, but is significantly simpler. Unlike X.500, LDAP supports TCP/IP, which provides for Internet access. U.S. Pat. No. 6,175,836, the contents of which are incorporated herein, shows an example LDAP directory that comprises a collection of hierarchically related objects. This directory is shown in FIG. 3. The structure of the directory and content of its objects are typically determined by the contents of a schema object which is normally itself stored in the directory. The contents of this schema object comprise a set of object class definitions and a set of structural rules, as shown for the above example in FIG. 4. The class definitions include a) a list of both mandatory (M) and optional (O) attributes for each object class allowed in the directory; and b) a list defining the hierarchical relationships between object classes and hence the inheritance rules for class definitions. In the above example, all object classes other than top are subclasses of the class top, thus inheriting the attribute object class. The structural rules control the arrangement of objects in the directory hierarchy and comprise a list of the allowed child object classes to each parent class and, for each such combination, the naming attribute(s) to be used to provide a unique relative distinguished name (RDN) for such an object. The RDN provides a unique name for an object at that point in the directory hierarchy. Its format is thus somewhat unpredictable for any object, as it is formed by a combination of one or more of the object's attributes and as can be seen from the naming attributes for employees, many different attributes may be used for an object at any one point in the tree. LDAP objects also have a unique name in the directory—the distinguished name (DN). The DN is formed by the successive, sequential concatenation of the RDNs of the object itself and its parents, back up to the root of the directory tree.

For corporate directory entries, country information appears below the topmost “root” node, followed by entries for companies, states or national organizations. Next come entries for organization units, such as branch offices and departments. Finally, individuals are located, which in LDAP includes people, shared resources (such as printers) and documents. An LDAP directory server thus makes it possible to maintain related information resources for a corporate user (he or she may be a collaboration system user) on the collaboration network.

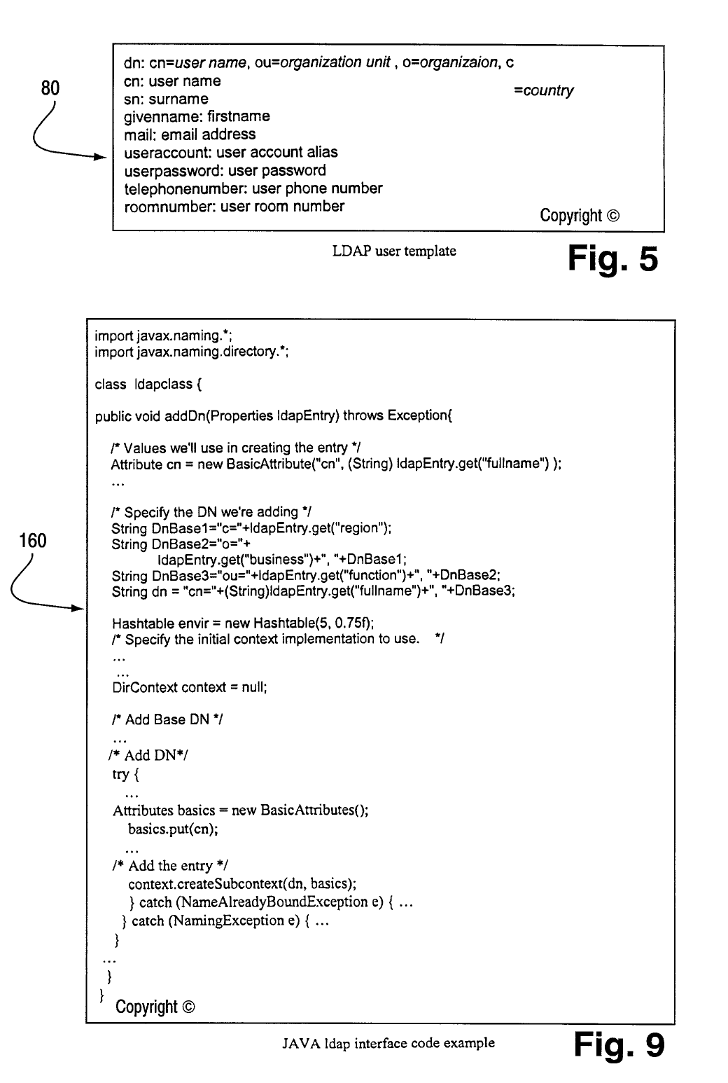

The collaboration control system and method disclosed herein utilizes LDAP to store user information such as user name, password, e-mail address, organization and country. FIG. 5 shows an example LDAP user template 80 which provides for storage of user name, organization unit, organization, country, surname, first name, e-mail address, user account alias, user password, user telephone number, and user room number. It will be readily apparent that other information may also be stored.

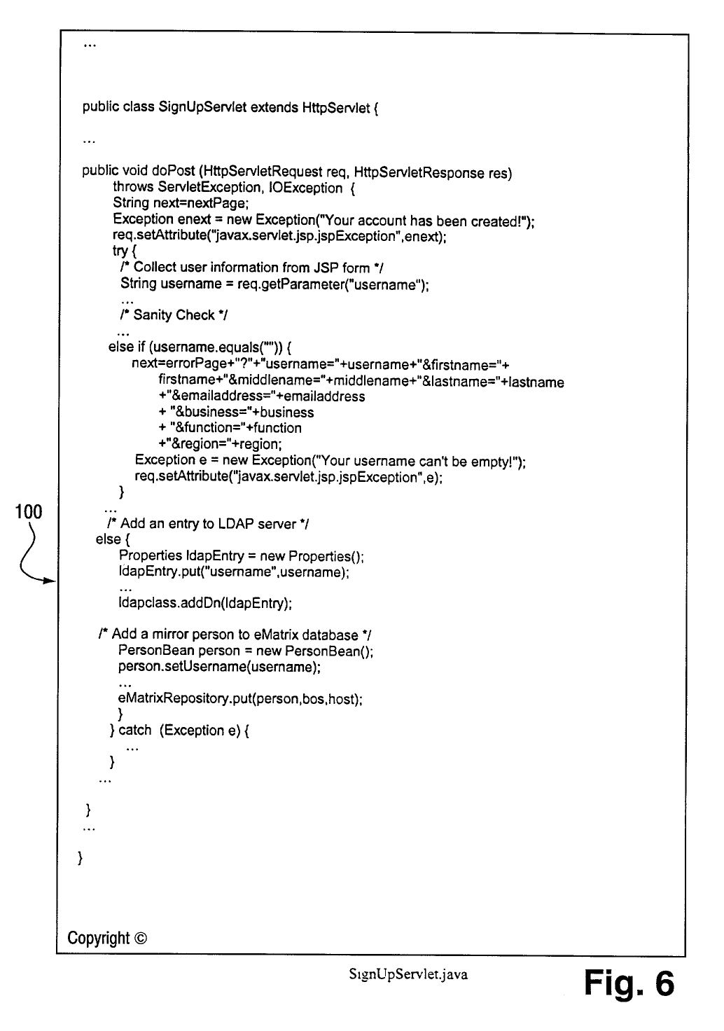

An information collection (registration) servlet collects user information for creating an account and generates mirror persons for the resources of the collaboration system. An example Java routine (servlet) 100 (SignUpServlet.java) for sign-up is shown in FIG. 6. “Servlet” refers to a Java program that runs as part of a network service, typically an HTTP server and responds to requests from clients. The sign-up information (e.g., username, first name, surname, e-mail address, etc.) is collected using a JavaServer Pages™ (JSP™) form. The user can create the account via a suitably equipped device connected to the world-wide web (e.g., a computer system configured with a modem and running a browser such as Microsoft Internet Explorer or Netscape Navigator). When the user has completed the sign-up information form, an appropriate entry is added to the LDAP server. The sign-up servlet also generates mirror persons for the resources of the collaboration system. The mirror persons each contains collaboration system-related identification for the user such as role, group and access privilege. This identification is used by the collaboration system to ensure that the user has appropriate access to and use of the resources. A collaboration system incorporates a large-scale complex system wherein a plurality of resources are involved. Each resource has its own rules for access control. Resources can be added to or removed from collaboration system dynamically. In order to capture complex access control rules in a plurality of dynamic resources, distributing user access privileges to the mirror persons inside resources is a flexible and scalable approach. When a user signs into the collaboration system, based on his or her particular request, the user is mapped to one or a number of mirror persons to retrieve resources. In other words, if he or she requests to access resource A, the mapped mirror person in resource A will determine whether he or she has the right to access this resource and what level of the resource he or she can access.

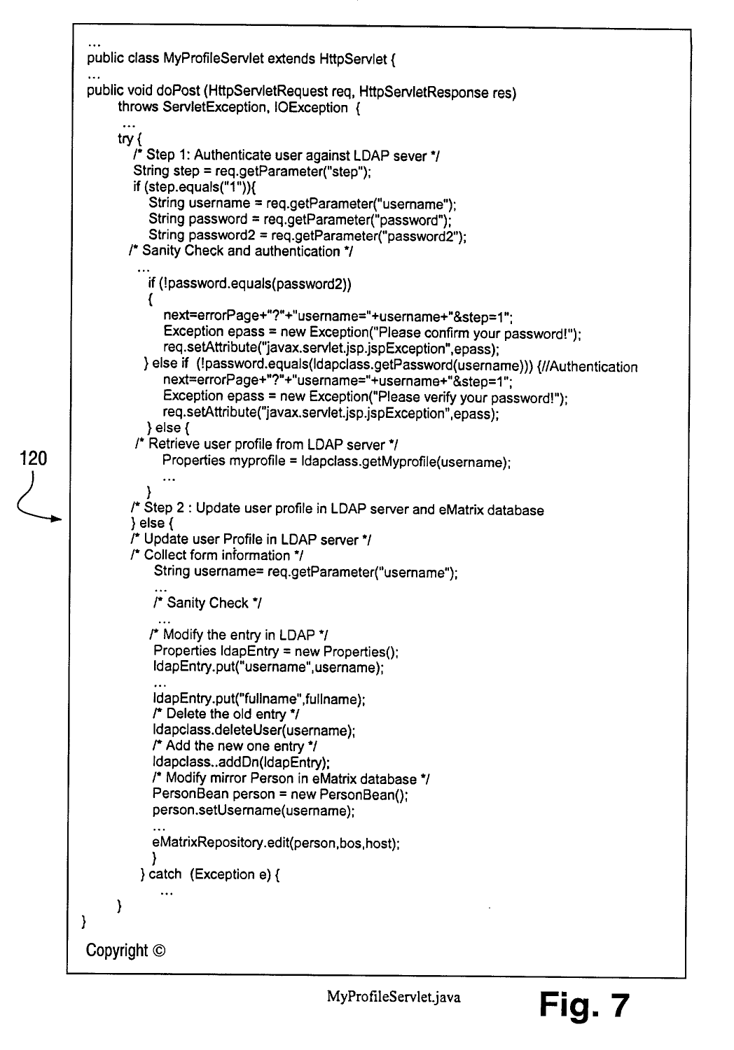

A profile management servlet permits a user to manage his/her profile. An example Java routine (servlet) 120 (MyProfileServlet.java) for profile management is shown in FIG. 7. The servlet includes an authentication step in which a user is authenticated by the correct entry of his/her password(s). Upon authentication, the user profile is retrieved from the LDAP server. The servlet also includes an update step in which the user can update the information in the retrieved user profile. When the user updates are completed, the revised entry is added to the LDAP server and the mirror persons in the collaboration system are modified.

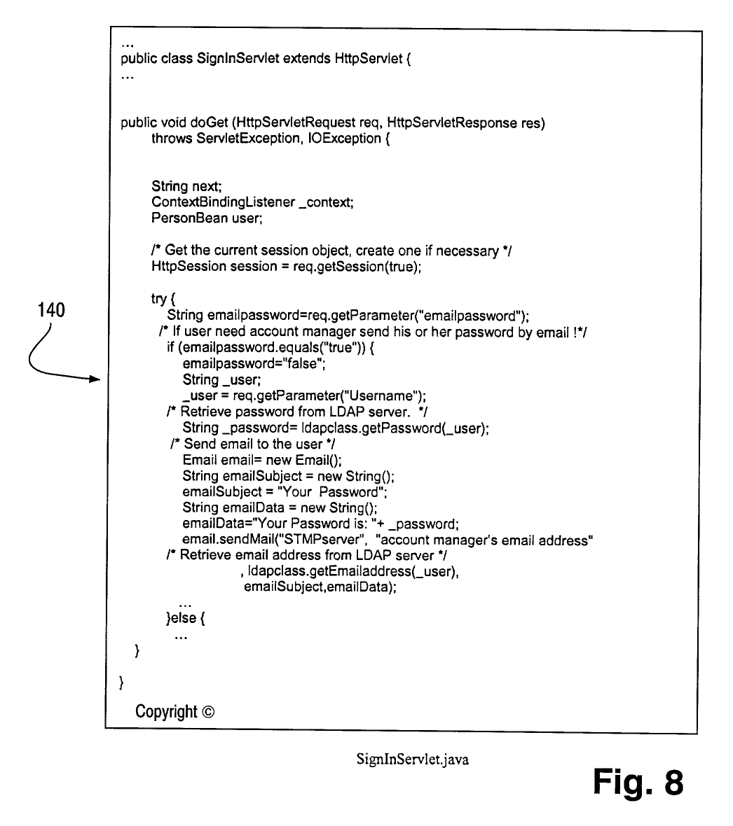

A sign-in and password notification servlet permits a user to sign in. An example Java routine (servlet) 140 (SignInServlet.java) for signing-in is shown in FIG. 8. The sign-in servlet contains code to authenticate the user and map the user to the right mirror persons based on user's request. The sign-in servlet also contains code for e-mailing a password to a user if the user forgets the password.

FIG. 9 shows an example account manager 160 coded with JAVA naming and directory services package. The account manager is an application programming interface to the LDAP server. It encapsulates the basic LDAP operations, such as adding a user account entry, and searching a user account, to a public JAVA class. The account manager is also coded with JAVA servlet and JAVA server pages. Therefore, it can be deployed to a JAVA web application server so that the user can access it through the world wide web.

The collaboration control system and method described above enable a user to the same username and password to identify himself/herself across multiple resources. This eliminates confusion among users resulting from multiple user names/passwords. In addition, the system and method ease the maintenance and updating of “persons” in the resources.

The example implementation described above may be implemented using eMatrix 8.5.1.0™, open LDAP 2.0 Release slapd (stand-alone LDAP Daemon) suite, and Weblogic® Version 5.1.

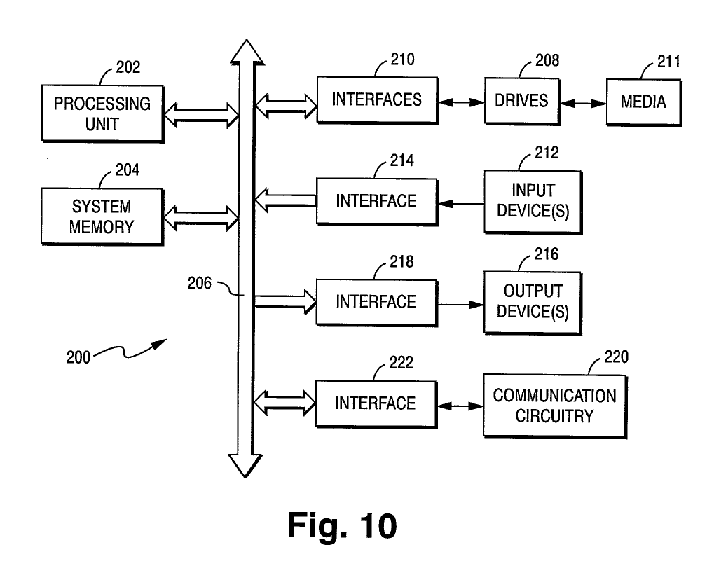

The various servlets may be executed on a computer system generally configured along the lines shown in FIG. 10. Computer system 200 includes a processing unit 202 and a system memory 204. A system bus 206 couples various system components including system memory 204 to processing unit 202. System bus 206 may be any of several types of bus structures including a memory bus or memory controller, a peripheral bus, and a local bus using any of a variety of bus architectures. System memory 204 includes read only memory (ROM) and random access memory (RAM). A basic input/output system (BIOS), containing the basic routines that help to transfer information between elements within computer system 200 is stored in the ROM. Computer system 200 further includes various drives 208 and associated computer-readable media 211. For example, a hard disk drive may read from and write to a (typically fixed) magnetic hard disk. A magnetic disk drive may read from and write to a removable “floppy” or other magnetic disk. An optical disk drive may read from and, in some configurations, writes to a removable optical disk such as a CD ROM or other optical media. Appropriate interfaces 210 may be provided to interface the various drives 208 to system bus 206. The drives and their associated computer-readable media provide nonvolatile storage of computer-readable instructions, data structures, program modules, and other data for computer system 200 including, but not limited to, the servlets and computer code shown in FIGS. 6-9.

A user may enter commands and information into computer system 200 through input devices 212 such as a keyboard, pointing device, microphones, or the like.

These and other input devices can be connected to processing unit 202 through an interface 214 (e.g., a serial port interface) that is coupled to system bus 206, but may be connected by other interfaces, such as a parallel port, or a universal serial bus (USB). Computer system 200 will typically include output devices 216, such as monitors, printers, speakers and other standard peripheral devices, connected to system bus 206 via interface 218.

Computer system 200 may also include communication circuitry 220 (e.g., a modem or other network interface circuitry) for establishing communications over a communication network such as the Internet. Communication circuitry 220 is connected to system bus 206 via an interface 222 (such as a serial port).

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

We claim:

1. A collaboration control system system for managing use of a plurality of resources, comprising:
a user information collection routine for collecting user account information for a user using the resources and creating an LDAP user account entry; and
a mirror routine for automatically generating mirror persons from the LDAP user account entry and maintaining the mirror persons within the resources to identify the user across the resources.

2. The collaboration control system according to claim 1, wherein the user information comprises a user name and a password.

3. The collaboration control system according to claim 1, wherein the resources comprise databases.

4. The collaboration control system according to claim 1, further comprising:
a profile management routine for updating the information in the user account entry.

5. The collaboration control system according to claim 1, further comprising:
a password notification routine for sending an electronic mail message to the user,
wherein the electronic mail message contains a user password.

6. The collaboration control system according to claim 1, wherein the resources are Internet-accessible.

7. A method of managing use of a plurality of resources, comprising:
collecting user account information for a user using the resources and creating an LDAP user account entry; and
automatically generating mirror persons from the LDAP user account entry; and
maintaining the mirror persons within the resources to identify the user across the resources.

8. The method according to claim 7, wherein the user information comprises a user name and a password.

9. The method according to claim 7, wherein the resources comprise databases.

10. The method according to claim 7, further comprising:
updating the information in the user account entry.

11. The method according to claim 7, further comprising:
sending an electronic mail message to the user,
wherein the electronic mail message contains a user password.

12. The method according to claim 7, wherein the resources are Internet-accessible.

13. A computer-readable medium having computer-executable instructions for managing use of a plurality of resources, the computer-executable instructions comprising:
a user information collection routine for collecting user account information for a user using the resources and creating and LDAP user account entry; and
a mirror routine for automatically generating mirror persons from the LDAP user account entry and maintaining the mirror persons within the resources to identify the user across the resources.

14. The computer-readable medium according to claim 13, further comprising:
a profile management routine for updating the information in the user account entry.

15. The computer-readable medium according to claim 13, further comprising:
a password notification routine for sending an electronic mail message to the user,
wherein the electronic mail message contains a user password.
